(19) United States
(12) Patent Application Publication
(10) Pub. No.: US 2017/0338636 A1
(43) Pub. Date: Nov. 23, 2017

(54) Enhanced Cover

(71) Applicant: Gregory Chabra, JR., Pittsburgh, PA (US)

(72) Inventor: Gregory Chabra, JR., Pittsburgh, PA (US)

(21) Appl. No.: 15/600,682

(22) Filed: May 19, 2017

Related U.S. Application Data
(60) Provisional application No. 62/338,639, filed on May 19, 2016.

(51) Int. Cl. H02G 3/14; H02G 3/12; H02G 3/18; H01R 13/447; H02G 3/04

(52) U.S. Cl. CPC H02G 3/14; H02G 3/18; H01R 13/447; H02G 3/12; H02G 3/0418

(57) ABSTRACT

An enhanced cover for enclosures such as gang boxes, offering additional unrelated functions at the same location as existing enclosure or gang box locations. The enhanced cover is network connected and can perform functions such as temperature monitoring and thermostatic control, smarthome command issuance via physical interaction, interpreting voice commands or relaying voice commands to third party services, monitoring room occupancy, serving as home security nodes, intercom functions, and other smarthome interactions. Further, display elements on the enhanced cover may allow for monitoring of the status of controlled devices or other configurable inputs.

### CROSS-REFERENCE TO RELATED APPLICATION

This application claims the benefit of U.S. Provisional Application No. 62/338,639 filed May 19, 2016.

### FIELD

The field is that of enclosure covers. One common embodiment of enclosure covers is the gang-box cover, also commonly referred to as a faceplate, wall plate, switch plate, switch plate cover, cover plate, etc.

### BACKGROUND

Common cover(s)/faceplate(s) serve to conceal or protect all or part of a housing or opening, or to provide aesthetic improvements to said housing or opening.

Stand-alone wireless controls provide dedicated functionality, and are installed separately from existing enclosure or gang box locations.

‘Smart’ switches provide enhanced functionality by replacing the existing device within the enclosure or gang box, or by installation within an additional or separate enclosure installation.

### SUMMARY

This document describes an enhanced cover for existing device(s) or housing(s) with embodiments that may incorporate wireless or wired data connectivity; power connectivity, supply, and/or battery; and controls and/or sensors to provide for operation of related or unrelated local or remote device(s). Embodiments replace any existing installed cover, providing additional functionality, with said functions not interfering with the functionality of the device(s) or housing(s) being covered, and optionally interacting via independent means with any device(s) operated by existing device(s).

### BRIEF DESCRIPTION OF THE DRAWINGS

FIG. 1 is a perspective view of a common example cover;

FIG. 2 is a perspective view of one embodiment;

FIG. 3 is a perspective view of another embodiment;

FIG. 4 is a perspective view of another embodiment;

FIG. 5 is a line drawing of additional embodiments;

FIG. 6 is a diagram of an example application of one embodiment;

FIG. 7 is a diagram of an example application of another embodiment;

### DETAILED DESCRIPTION

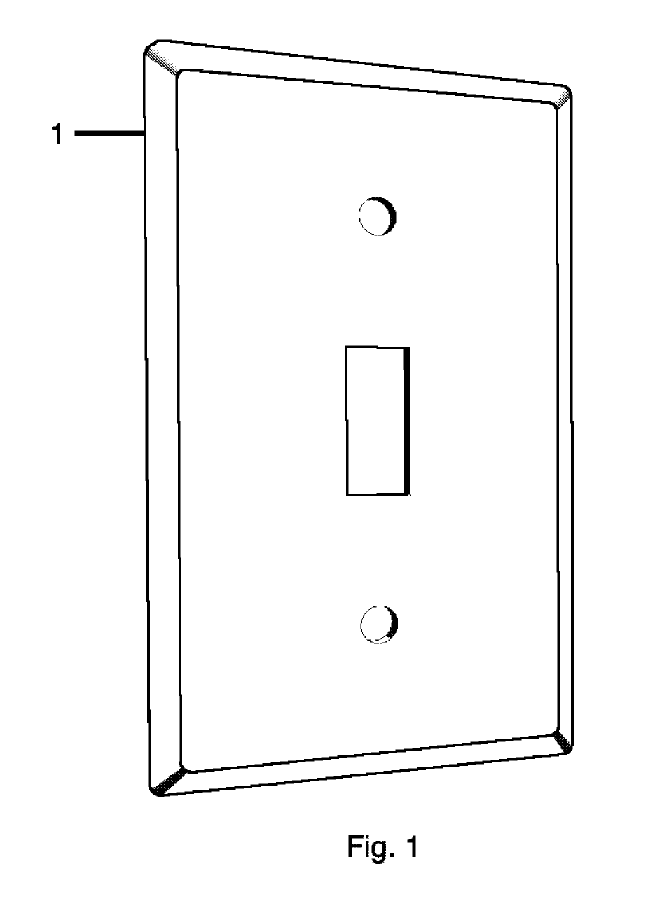

In FIG. 1 there is shown an example of a common embodiment of a cover. This example standard single-gang cover is for covering an electrical switch, and comprises a body of dimensions adequate to cover a gang box, an opening to allow for access to the enclosed device, and provisions for mounting the cover to the device, gang box, or wall.

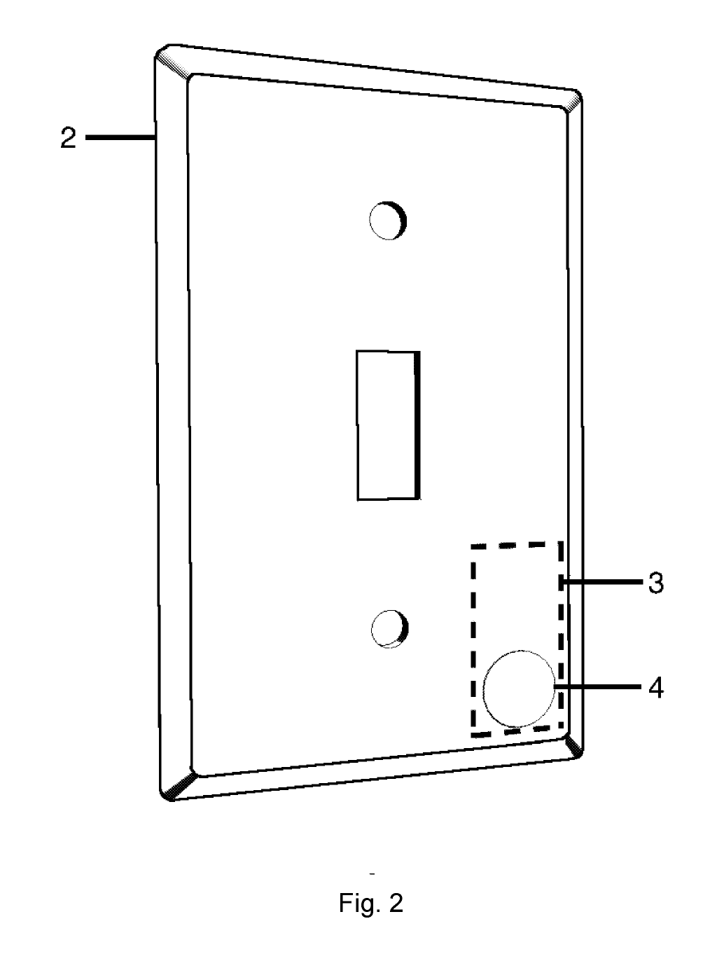

Referring now to the enhanced cover, in FIG. 2 there is shown an enhanced cover embodiment 2. The embodiment body may be constructed of plastic, vinyl, metal, fiberglass, or any other material appropriate for the application.

In more detail, still referring to FIG. 2, the embodiment has one or more circuit(s) 3. The circuit(s) may be embedded in the enhanced cover, or affixed to the front or back of the enhanced cover via screws, clips, adhesive, or similar means as appropriate for the specific application. Said circuit(s) include or connect one or more of any combination of component(s) including power supply(s), network component(s), sensor(s), display(s), control(s), and/or transducer(s). Said component(s), if present, may each be independent of, and provide functionality independent from, that of any device(s) being partially or fully covered by the embodiment. Components may be mounted behind, within, to the surface of, or penetrate the enhanced cover material as appropriate for the specific application.
a. Power supply(s) may each be on-device supply(s) (e.g. battery(s), capacitor(s), photovoltaic(s) etc), connection(s) to off-device supply(s) (e.g. home A/C power, home low-voltage wiring, connection to Power-Over-Ethernet, etc), or methods of deriving power from ambient source(s) (e.g. photovoltaic(s), inductive pickup(s), EM spectrum harvester(s), thermal change power generator(s), etc).
b. Network components may include hardware such as antennas, ports, transmitters, etc as appropriate for the specific application. Supporting circuitry or components may be present to provide for common network functions such as DHCP, DNS, HTTP, FTP, encryption, or other services appropriate for the specific application. One or more network type(s) may be employed depending upon the specific application. Network type(s) may each be wireless (e.g. Wi-Fi, Li-Fi, Zygbee, Z-Wave, bluetooth, RF, IR, passive/low power wireless implementations, proprietary wireless protocol(s), etc) or wired (e.g. ethernet, data-over-powerline, serial port, etc) as appropriate for the specific application.
c. Sensor(s), if present, may each be any of a variety of types, including temperature, motion, proximity, IR, light, humidity, sound (microphone), acceleration, orientation, touch, RF, or any other types of sensor(s), and may be used for environmental monitoring, occupancy detection, voice commands, or any other function as appropriate for the intended application.
d. Display(s), if present, may provide visual feedback of circuit(s) status. Display(s), if present, may each be of any configuration(s) including single indicator light(s), segmented display(s), bitmapped display(s), or any other configuration(s). Display(s), if present, may each be of any type(s) including LED, LCD, OLED, EL, or any other type(s).
e. Control(s), if present, may each be independent of, and provide functionality independent from, that of any device(s) being partially or fully covered by the embodiment. Control(s), if present, may each be any of a variety of types, including mechanical toggle switch, pushbutton switch, touch-sensitive control, rotary control, slider, temperature sensor, motion sensor, proximity sensor, IR sensor, light sensor, humidity sensor, sound sensor, vibration sensor, or any other types of control(s).
f. Transducer(s), if present, may be independent of, and provide functionality independent from, that of any device(s) being covered by the embodiment. Transducer(s), if present, may each be any of a variety of types, including voice coil, piezo, or any other types of transducer(s) or speaker(s).

In more detail, still referring to FIG. 2, this embodiment includes a temperature sensor component 4, which may be directly connected to the circuit 3, or connected by wiring, wireless, or other means.

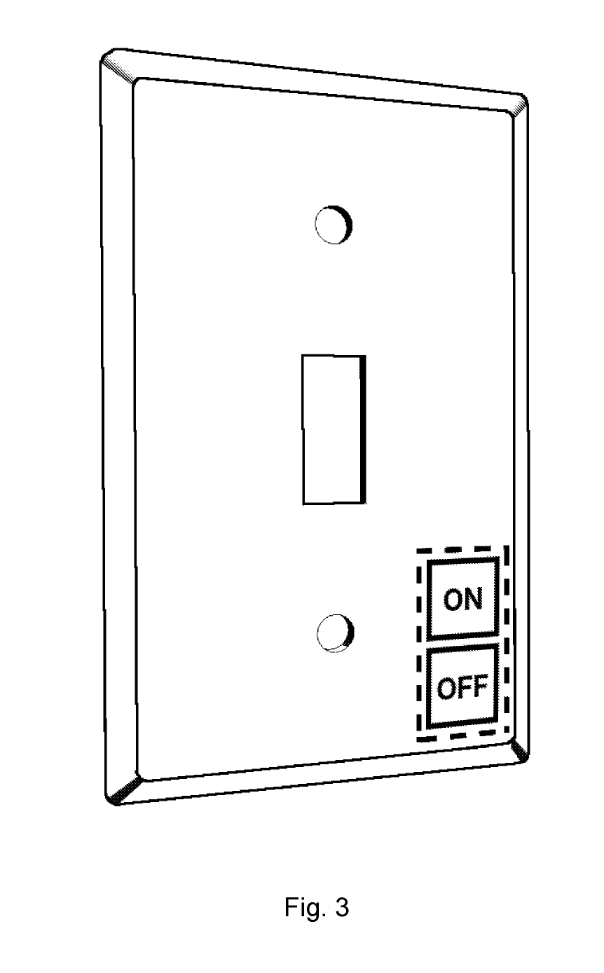

Referring now to the enhanced cover in more detail, in FIG. 3 there is shown an additional embodiment. This embodiment includes a circuit, represented by the dashed rectangle, which incorporates power supply component(s) as previously described (not shown), network connection components as previously described (not shown), and pushbutton control components represented by the squares labeled ‘ON’ and ‘OFF’. These pushbutton components, combined with the circuit and related components, permit the transmission of control signals for operation of an auxiliary device separate and distinct from any device controlled by the switch which is covered by the embodiment.

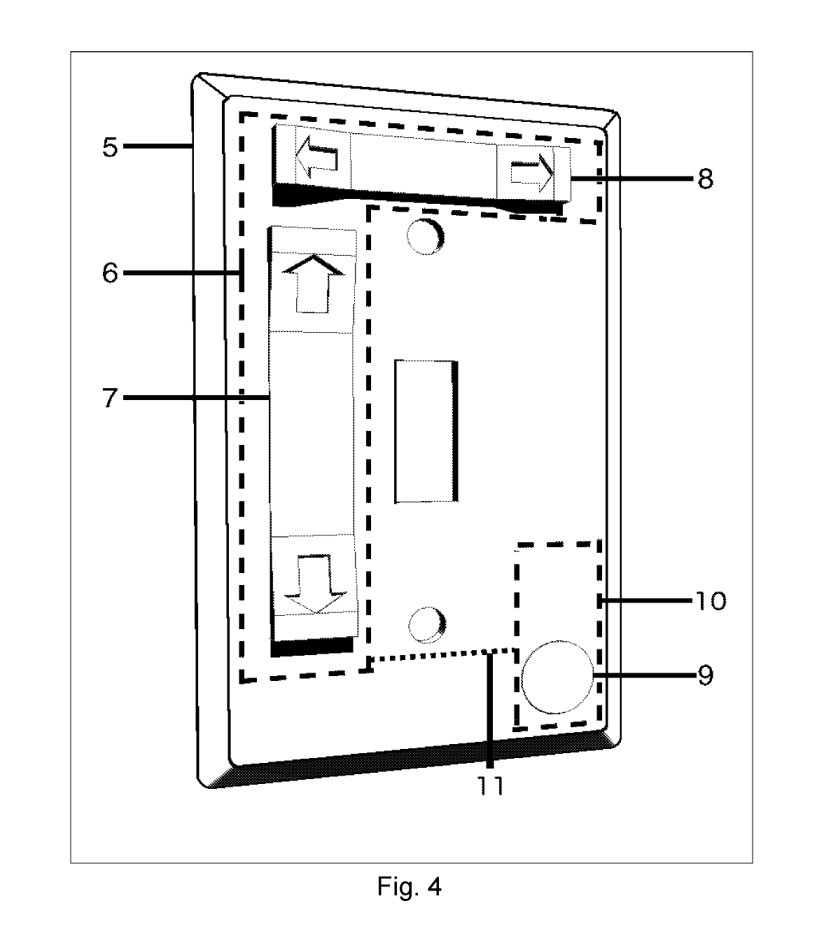

Referring now to the enhanced cover in more detail, in FIG. 4 there is shown an additional embodiment 5. Embodiment 5 illustrates two circuits 6 and 10; a connection between the circuits 11; and multiple components (one sensor 9, and two rocker switches 7 and 8). This illustration is intended to convey that all components (circuit(s), power supply(s), network connection(s), sensor(s), display(s), control(s), and/or transducer(s)) present in the embodiment may be aligned or located at any position(s) on the embodiment as appropriate for the specific application.

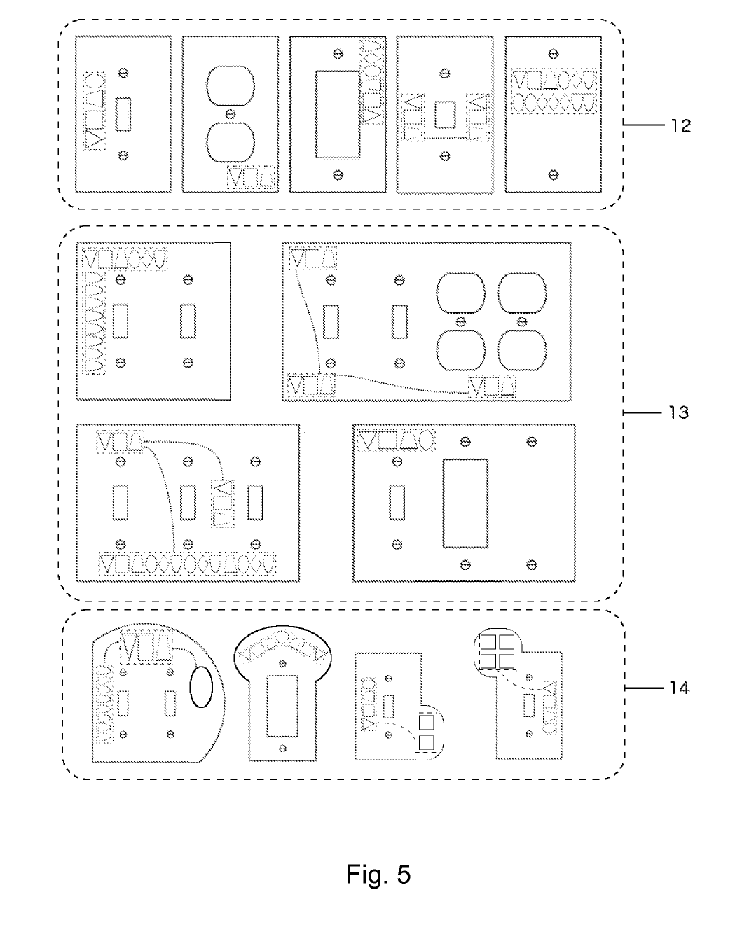

Referring now to the enhanced cover in more detail, in FIG. 5 there are shown some additional embodiments, each having any number of circuits and devices as previously described, represented in FIG. 5 as various shapes (square, circle, triangle, trapezoid, etc). Area 12 illustrates that the enhanced cover can be applied to single gang devices. Area 13 illustrates that the enhanced cover can be applied to multiple gang devices of any configuration; and Area 14 illustrates that the form factor of the of the enhanced cover is not limited to standard dimensions or shapes, allowing for expansion of the enhanced cover to accommodate various openings, enclosed devices, and integrated components as appropriate for the specific application.

In more detail, still referring FIG. 5, all embodiments depicted are intended to illustrate that the enhanced cover can be employed as a covering for enclosures with or without common devices such as switches, outlets, ‘decora’ devices, telecom jacks, or completely concealed items such as splices, junctions, transformers, etc. and that multiple elements of the enhanced cover may be employed as appropriate for the specific application.

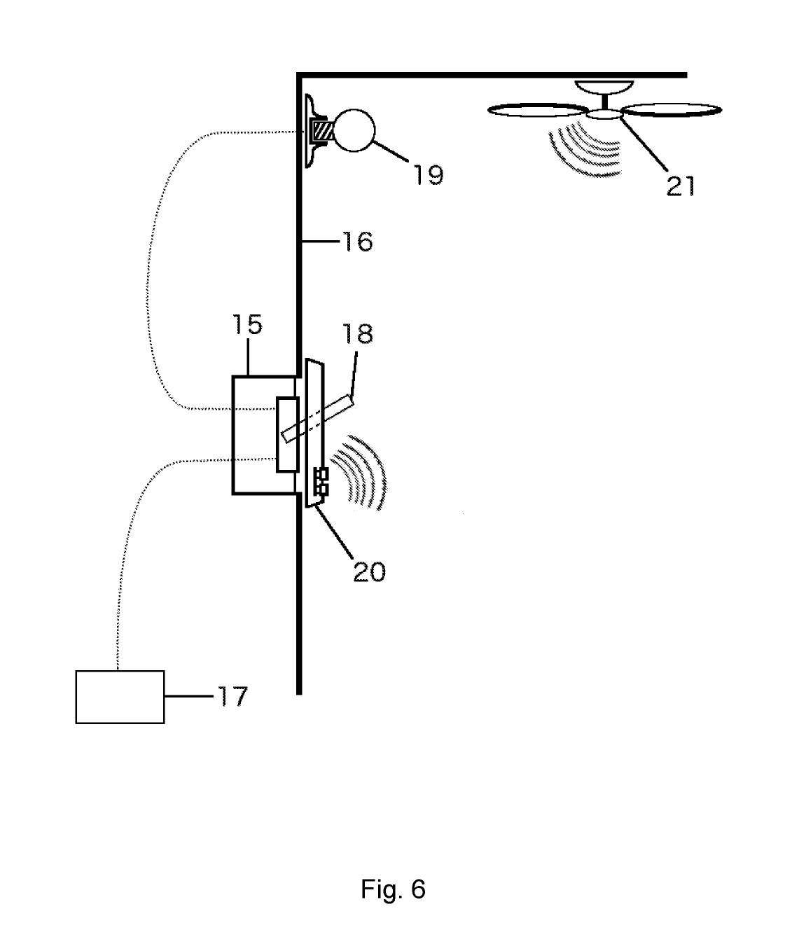

FIG. 6 is a diagram illustrating one application of the embodiment shown in FIG. 3. Specifically, this example application enables control of a ceiling fan from a light switch location by replacing the existing gang box cover with an enhanced cover embodiment.

In more detail, still referring to FIG. 6, the embodiment does not control the existing switch 18, but instead provides new functionality (control of a ceiling fan) at the location of gang box 15 without replacing the contents of the gang box.

In more detail, still referring to FIG. 6, there is a gang box 15 installed in a wall 16. A home electrical system 17 supplies power to an existing switch device 18. The switch device 18 controls a room light 19.

In more detail, still referring to FIG. 6, an embodiment 20 is installed to replace the existing cover of the gang box 15. Existing switch device 18 protrudes through the opening provided by embodiment 20. Embodiment 20 does not obstruct, interfere with, or otherwise interact with existing switch device 18.

In more detail, still referring to FIG. 6, the embodiment 20 includes circuitry, power supply, wireless network, and push button (ON′ and ‘OFF’) components. When the push button components are actuated by the user, a wireless signal is generated by the embodiment for control of the ceiling fan 21, which is not connected to or otherwise controlled by existing switch device 18. Note that ceiling fans are not the only auxiliary device types that can be controlled; the enhanced cover can employ embodiments for control of any device with network connectivity (e.g. garage door openers, smart locks, wireless lights, window coverings, etc).

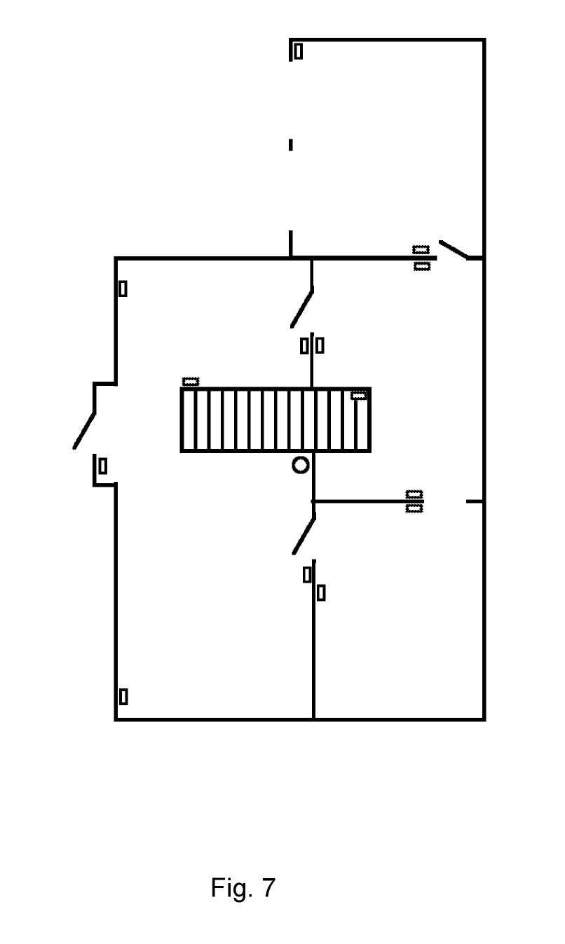

An example application of the embodiment shown in FIG. 4 is depicted in FIG. 7. This example application creates a distributed temperature sensing network for the home, allowing for enhanced monitoring of temperatures throughout the home as opposed to the single-point monitoring that traditional thermostats provide. FIG. 7 illustrates a home floorplan. In this example application, an enhanced cover with power, temperature sending, wireless networking devices, and other components has been used to replace the existing switch and/or outlet covers at the locations indicated by small rectangles. The existing electrical switches and outlets were left in place within their gang boxes and retain all original functionality. Each of the enhanced covers senses the temperature at it's location and transmits that information wirelessly to a smart home controller, represented here by the small circle. The smart home controller may be placed at any location so long as it is within wireless range of the embodiments. The wireless connections are omitted from this diagram for clarity, but such connectivity may be point-to-point, mesh, or other network topologies as appropriate for the specific installation. Note that any or all of the enhanced covers may be of any embodiment appropriate for the specific location (e.g. FIG. 2, FIG. 3, FIG. 4, any of FIG. 5, or any other embodiment as appropriate for the specific application). For example, the enhanced cover(s) located near the garage entry door may include a ‘button’ component, with the network configured to pass that signal to the garage door opener. In this manner, enhanced covers each replace the existing covers, transmitting temperature readings to the smart home controller, and additionally transmitting commands to open or close the garage door to the smart home controller. The controller then interprets the sensor data and/or switch commands, and processes each in a manner determined by the smart home controller programming or services.

Another example application of an embodiment including a microphone includes integration with voice activated third party services such as Google Home or Amazon Alexa. Installation of an embodiment can take the place of a tabletop voice interface, and allows for commands to be interpreted differently based upon the location of the embodiment (e.g. which room the embodiment is in, or which embodiment within a given room is being utilized)

The advantages of an enhanced cover may include, without limitation, that it provides for controls and sensors that operate independently or optionally in concert with any controls or interfaces on the device being covered.

In broad embodiment, an enhanced cover is a cover including networking, power, control(s), display(s), transducer(s), and/or sensor(s) in a form factor suitable to replace existing cover(s) and provide enhanced functionality at the cover location without replacing or interfering with the enclosure contents.

While the foregoing written description of enhanced covers enables one of ordinary skill to make and use what is considered presently to be the best mode thereof, those of ordinary skill will understand and appreciate the existence of variations, combinations, and equivalents of the specific embodiment, method, and examples herein. The enhanced cover should therefore not be limited by the above described embodiments, methods, and examples, but by all embodiments and methods within the scope and spirit of the enhanced cover as claimed. For example, the form factor of the enhanced cover may be altered to enable the covering of enclosures other than gang boxes, such as rough wall openings, mobile device battery compartments, or similar enclosures or access panels requiring covers. It is, therefore, to be understood that the within the scope of the appended claim, the enhanced cover may be practiced otherwise than as specifically described.

What is claimed is:

1. A cover to be installed on a standard enclosure such as a single gang box, multiple gang box, or similar, comprising:
a. a body, sized and provisioned so as to enable installation on said enclosure or replacement of an existing cover on said enclosure;
b. one or more openings in said body to allow for access to any existing device(s) requiring said openings, such as electrical switch(s), dimmer(s), outlet(s), network jack(s) or other existing device(s) installed within said enclosure, allowing said cover to be installed without interfering with the functionality of said existing device(s);
c. electrical circuitry and attached devices configured to provide function(s) independent of said existing device(s), and the electrical circuitry and attached device(s) comprising:
i. one or more circuit-connected power supply(s), such as electrical connection(s), battery(s), photovoltaic cell(s), RF energy harvester(s), or other supply(s);
ii. one or more circuit-connected network communication device(s);
iii. one or more circuit-connected devices such as sensor(s), microphone(s), controls(s), display(s), and/or transducer(s);
iv. circuit(s) and logic capable of interacting with said circuit-connected device(s), processing the results of said interactions, and transmitting the results of said processing to remote device(s) or service(s) via the said network communication device(s);
v. circuit(s) and logic capable of receiving inbound communications from remote source(s) via said network communication device(s), processing said inbound communication, and communicating the results of said processing to appropriate circuit-connected device(s) or issuing further command(s) to said network communication device(s)

2. A cover as recited in claim 1, with said body lacking in body openings, for covering said enclosures that contain no existing devices, or for covering said enclosures containing existing devices that do not require said openings.
